(19) United States
(12) Patent Application Publication
(10) Pub. No.: US 2016/0304067 A1
(43) Pub. Date: Oct. 20, 2016

(54) BRAKING SYSTEMS AND METHODS FOR AUTOMATIC TRAIN OPERATION

(71) Applicant: Electro-Motive Diesel, Inc., LaGrange, IL (US)

(72) Inventors: Venkata Swamy Reddy Gajulapalli, Naperville, IL (US); Russell Kubycheck, Clarendon Hills, IL (US); James Seaton, Westmont, IL (US); Alexander Shubs, JR., Chicago, IL (US); Ola Tannous, LaGrange, IL (US); David J. Babinec, Lemont, IL (US)

(73) Assignee: Electro-Motive Diesel, Inc., LaGrange, IL (US)

(21) Appl. No.: 14/688,672

(22) Filed: Apr. 16, 2015

(51) Int. Cl. B60T 7/12; B61H 9/04; B60T 8/17

(52) U.S. Cl. CPC B60T 7/128; B60T 8/1705; B61H 9/04

(57) ABSTRACT

A system comprises a controller configured to determine whether to engage a parking brake upon detecting a fault. The system also includes a parking brake control system designed to automatically engage and release the parking brake in response to a command from the controller. The system also includes a communication system configured to facilitate communication between the controller and the parking brake control system.

### TECHNICAL FIELD

This disclosure relates generally to automatic train operation and, more specifically, to a system and method for braking in automatic train operation systems.

### BACKGROUND

A goal of automatic train operation (ATO) systems is to eliminate the need for an operator aboard the train. Many trains with ATO still include an operator for handling fault conditions under which braking, such as emergency braking, may be desirable.

One proposed implementation of automatic braking is described in U.S. Patent Application Publication No. 2014/0097667 A1 (“the '667 publication”). The '667 publication discloses a method for controlling a brake system of a vehicle that includes coupling a magnet valve to an air brake system of a vehicle that includes a first valve also coupled with the air brake system. Each of the magnet valve and the first valve is configured to be separately controlled to block or permit flow of air out of the air brake system to activate the air brake system. The method also includes connecting the magnet valve to an automatic control system of the vehicle. The automatic control system is configured to communicate one or more control signals to the first valve and the magnet valve to cause at least one of the first valve and the magnet valve to open and allow the air to flow out of the air brake system to activate the air brake system. The method further includes configuring the automatic control system to communicate a second control signal of the one or more control signals to the magnet valve responsive to the automatic control system previously communicating a first control signal of the one or more control signals to the first valve and the air brake system not being activated. The second control signal is communicated to the magnet valve to open the magnet valve and activate the air brake system.

The method and system provided by the '667 publication may be subject to a number of possible drawbacks. For example, the method and system of the '667 publication only provides for remote control of air brakes to stop a moving vehicle. It may be advantageous to provide for remote control of parking brakes to keep a stopped vehicle from moving. Further, it may be advantageous to remotely control parking brakes to keep a stopped vehicle from a rollover incident.

The presently disclosed systems and methods are directed to overcoming one or more of the problems set forth above and/or other problems in the art.

### SUMMARY

In one aspect, this disclosure is directed to a system. The system may include a controller configured to determine whether to engage a parking brake upon detecting a fault. The system may also include a parking brake control system designed to automatically engage and release the parking brake in response to a command from the controller. The system may also include a communication system configured to facilitate communication between the controller and the parking brake control system.

According to another aspect, this disclosure is directed to a vehicle. The vehicle may include a plurality of wheels and at least one parking brake configured to physically engage at least one of the plurality of wheels. The vehicle may also include a controller configured to determine whether to engage the at least one parking brake upon detecting a fault. The vehicle may also include a parking brake control system designed to automatically engage and release the at least one parking brake and a communication system configured to facilitate communication between the controller and the parking brake control system.

According to another aspect, this disclosure is directed to a computer-implemented method for controlling a plurality of parking brakes. The method may include receiving a fault signal indicative of a fault condition of a vehicle. The method may also include determining a number of parking brakes to engage to keep the vehicle motionless. The method may also include sending a command to a parking brake control system to engage the determined number of parking brakes.

### BRIEF DESCRIPTION OF THE DRAWINGS

FIG. 1 provides an exemplary embodiment of a locomotive.

FIG. 2 is a schematic of a braking system.

FIG. 3 is flowchart of a process of controlling parking brakes.

### DETAILED DESCRIPTION

Reference will now be made in detail to the exemplary embodiments implemented according to the disclosure, the examples of which are illustrated in the accompanying drawings. Wherever possible, the same reference numbers will be used throughout the drawings to refer to the same or like parts.

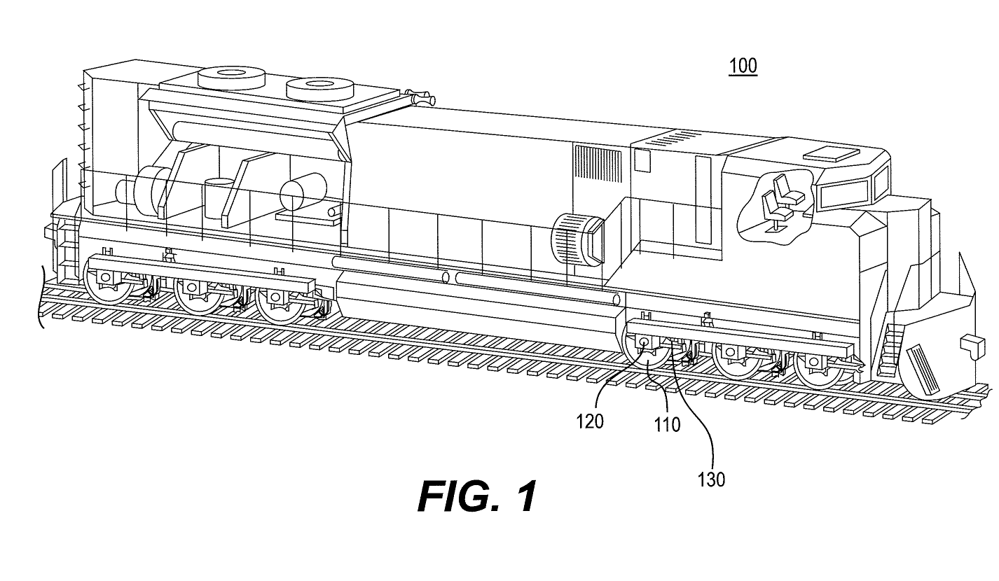

FIG. 1 shows an exemplary vehicle, for example, a locomotive 100, in which systems and methods for automatic train operation (ATO) may be implemented consistent with the disclosed exemplary embodiments. For example, locomotive 100 may be any electrically powered rail vehicle employing alternating-current traction motors for propulsion. According to the exemplary embodiment illustrated in FIG. 1, locomotive 100 may include a pair of wheels 110 connected to an axle 120, and brakes 130. According to some embodiments, brakes 130 may include parking brakes, also known as emergency brakes.

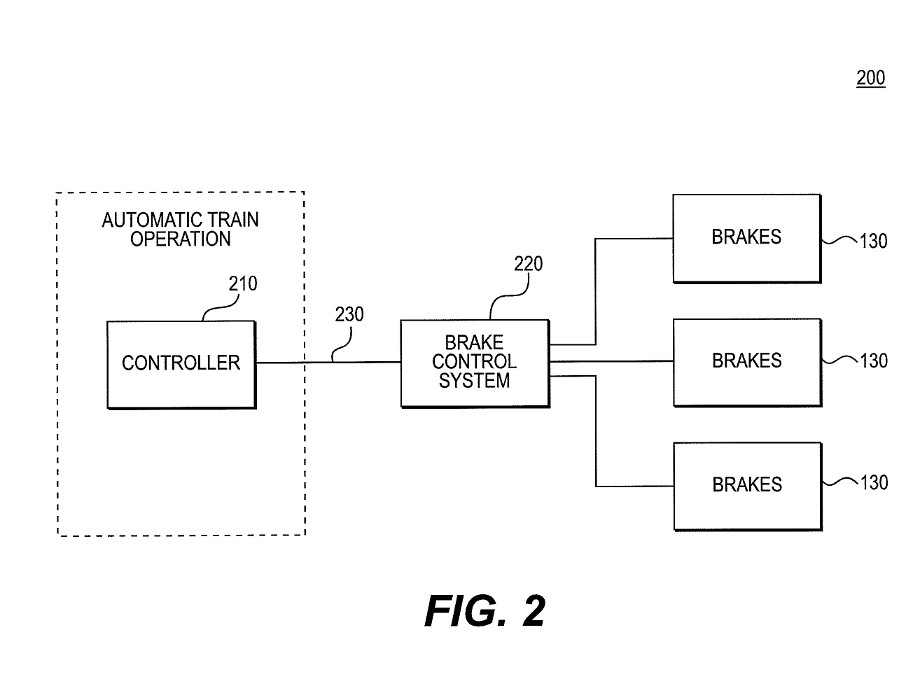

FIG. 2 schematically illustrates one example of a system 200 that may be implemented in locomotive 100. System 200 may include a controller 210 configured to determine whether to engage parking brake 130. Optionally, controller 210 may be part of a larger ATO system. Controller 210 may make a determination that the parking brake should be engaged based on a signal it receives and processes. For example, controller 210 may receive a signal from another subsystem indicating that a fault of locomotive 100 is present. For example, controller 210 may be configured to detect a fault condition of locomotive 100. This may be accomplished by monitoring certain sensors and/or receiving a user input. According to some embodiments, a fault condition may be detected based upon a signal received from the larger ATO system or any other systems affiliated with locomotive 100.

The fault signal may be indicative of a failure of an essential locomotive system, such as, for example, a cooling system and/or an engine failure. The fault signal may be indicative of an emergency situation of locomotive 100, such as a fire or other hazardous event. Additionally or alternatively, the fault signal may be the result of a user input. The fault signal may be indicative of an external condition. For example. a fault signal may be sent if an object is found to be blocking the path of locomotive 100.

Controller 210 may be optionally configured to determine a number of parking brakes 130 to engage to keep locomotive 100 motionless. This determination may be based on a number of factors, including how many cars are connected to locomotive 100, the grade of the surface on which locomotive 100 rests, the center of gravity of locomotive 100, and/or the weight of locomotive 100 and/or its load. For example, if the weight distribution of locomotive 100 is balanced and the surface grade is low, it may be desirable to engage fewer brakes 130 than if the weight distribution of locomotive 100 has shifted its center of gravity and the surface grade is high. According to some embodiments, the number of parking brakes 130 may be the number of parking brakes present on locomotive 100 and any connected cars.

When controller 210 receives a signal indicating a fault condition of locomotive 100, depending on the type of fault condition, controller 210 may send a signal to a parking brake control system 220 to engage brakes 130. This may be done in conjunction with the use of other braking methods, including dynamic and/or pneumatic braking. That is, once locomotive 100 is motionless, controller 210 may command engagement of parking brakes 130 to keep locomotive 100 motionless. Controller 210 may communicate this signal to parking brake control system 220 through a communication system 230, such as a wired connection. Additionally or alternatively, communication system 230 may include any form of wireless or wired communication, including Wi-Fi, radio frequency, point-to-point communication, cellular communication, or any other telecommunications systems. The signal sent via communication system 230 may be indicative of a command to engage and/or release parking brake 130.

Parking brake control system 220 may be designed to automatically engage and release parking brake 130 in response to a command from controller 210. Parking brake control system 220 may include motors, levers, gears and/or actuators to control parking brake 130. Parking brake control system 220 may use power from an electronic pneumatic braking system, mechanical potential energy, and/or battery power to engage parking brakes 130.

Controller 210 may command parking brake control system 220 to release parking brake 130 if it detects that a fault condition no longer exists. According to some embodiments, for safety, the controller 210 may send a release command only after receiving a user override command. Additionally or alternatively, controller 210 may determine that the fault condition no longer exists based on commands or signals received from other systems of locomotive 100.

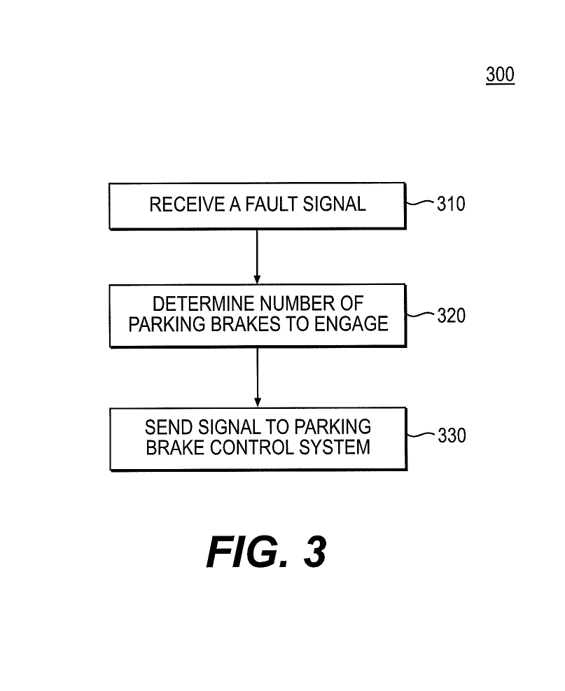

FIG. 3 is a flowchart of an exemplary computer-implemented method 300 for controlling a plurality of parking brakes 130. This method may include, at step 310, receiving a fault signal indicative of a fault condition of locomotive 100. As discussed previously, the fault signal may be received from an ATO system or from a user. The fault signal may be indicative of either an internal or external problem with locomotive 100. According to some embodiments, the fault may be an issue internal to locomotive 100 and controller 210 may be configured to detect the fault based on a signal transmitted by an automatic train operation system. Additionally or alternatively, the fault may be an issue external to locomotive 100 and controller 210 may be configured to detect the fault based on a signal based on a user input.

At step 320, controller 210 may determine a number of parking brakes 130 to engage to keep locomotive 100 motionless. This determination may be based on a number of factors, including how many cars are connected to locomotive 100, the grade of the surface on which locomotive 100 rests, the center of gravity of locomotive 100, and/or the weight of locomotive 100 and/or its load.

At step 330, controller 210 may send a command to parking brake control system 220 to engage the determined number of parking brakes 130. Then, parking brake control system 220 may automatically engage the determined number of parking brakes 130.

Embodiments herein include computer-implemented methods, systems, and user interfaces. The computer-implemented methods may be executed, for example, by at least one processor that receives instructions from a non-transitory computer-readable storage medium. Similarly, systems consistent with the present disclosure may include at least one processor and memory, and the memory may be a non-transitory computer-readable storage medium. As used herein, a non-transitory computer-readable storage medium refers to any type of physical memory on which information or data readable by at least one processor may be stored. Examples include random-access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” may additionally refer to multiple structures, such a plurality of memories and/or computer-readable storage mediums. As referred to herein, a “memory” may include any type of computer-readable storage medium unless otherwise specified. A computer-readable storage medium may store instructions for execution by at least one processor, including instructions for causing the processor to perform steps or stages consistent with embodiments herein. Additionally, one or more computer-readable storage mediums may be utilized in implementing a computer-implemented method. The term “computer-readable storage medium” should be understood to include tangible items and exclude carrier waves and transient signals.

### INDUSTRIAL APPLICABILITY

The disclosed systems and methods provide a robust solution for automatic train control braking systems and methods. The presently disclosed systems and methods may have several advantages over other attempted solutions. For example, the disclosed systems and methods provide a way to remotely engage parking brakes of vehicles. Additionally, the disclosed systems and methods disclose means of remotely powering an actuator to engage a particular number of parking brakes. This may be advantageous because an automatic response to a fault condition can decrease any delay between identifying a fault and reacting to that fault by braking. Further, an automatic braking system may be advantageous for locomotives that are not being controlled by an onboard operator.

It will be apparent to those skilled in the art that various modifications and variations can be made to the automatic train operation systems and associated methods for operating the same. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A system comprising:
a controller configured to determine whether to engage a parking brake upon detecting a fault;
a parking brake control system designed to automatically engage and release the parking brake in response to a command from the controller; and
a communication system configured to facilitate communication between the controller and the parking brake control system.

2. The system of claim 1, wherein the communication system includes a wired connection.

3. The system of claim 1, wherein the fault is an issue internal to a locomotive and the controller is configured to detect the fault based on a signal transmitted by an automatic train operation system.

4. The system of claim 1, wherein the fault is an issue external to a locomotive and the controller is configured to detect the fault based on a signal based on a user input.

5. The system of claim 1, wherein the controller is configured to send a command to release the parking brake to the parking brake control system upon detecting that the fault no longer exists.

6. The system of claim 5, wherein the controller detects that the fault no longer exists based upon a user override command.

7. The system of claim 1, wherein the parking brake control system is powered by at least one of an electronic controlled pneumatic braking system, battery, and mechanical potential energy.

8. The system of claim 1, wherein the controller is configured to determine a number of parking brakes necessary to engage to keep a vehicle motionless.

9. The system of claim 8, wherein the number of parking brakes necessary is based upon a center of gravity of the vehicle.

10. A vehicle comprising:
a plurality of wheels;
at least one parking brake configured to physically engage at least one of the plurality of wheels;
a controller configured to determine whether to engage the at least one parking brake upon detecting a fault;
a parking brake control system designed to automatically engage and release the at least one parking brake; and
a communication system configured to facilitate communication between the controller and the parking brake control system.

11. The vehicle of claim 10, wherein the communication system includes a wired connection.

12. The vehicle of claim 10, wherein the fault is an issue internal to the vehicle and the controller is configured to detect the fault based on a signal transmitted by an automatic train operation system.

13. The vehicle of claim 10, wherein the fault is an issue external to the vehicle and the controller is configured to detect the fault based on a signal based on a user input.

14. The vehicle of claim 10, wherein the controller is configured to send a signal indicative of a command to release the at least one parking brake to the parking brake control system upon detecting that the fault no longer exists.

15. The vehicle of claim 10, wherein the parking brake control system is powered by at least one of an electronic controlled pneumatic braking system and mechanical potential energy.

16. The vehicle of claim 10, wherein the controller is configured to determine a number of parking brakes to engage to keep the vehicle motionless.

17. The vehicle of claim 16, wherein the controller is configured to determine a number of parking brakes to engage to keep the vehicle motionless based upon at least one of a surface grade and a weight distribution of the vehicle.

18. A computer-implemented method for controlling a plurality of parking brakes comprising:
receiving, by a controller, a fault signal indicative of a fault condition of a vehicle;
determining, by the controller, a number of parking brakes to engage to keep the vehicle motionless; and
sending, by the controller, sending a command to a parking brake control system to engage the determined number of parking brakes.

19. The method of claim 18, wherein the fault signal is received from an automatic train operation system.

20. The method of claim 18, wherein the parking brake control system includes an electronic controlled pneumatic braking system.
